(19) United States
(12) Patent Application Publication
(10) Pub. No.: US 2022/0078158 A1
(43) Pub. Date: Mar. 10, 2022

(54) PROCESSING SYSTEM AND PROCESSING METHOD

(71) Applicant: Hitachi, Ltd., Tokyo (JP)

(72) Inventors: Nodoka Mimura, Tokyo (JP); Masayuki Takase, Tokyo (JP); Takeshi Shibata, Tokyo (JP)

(73) Assignee: Hitachi, Ltd., Tokyo (JP)

(21) Appl. No.: 17/464,873

(22) Filed: Sep. 2, 2021

(30) Foreign Application Priority Data
Sep. 4, 2020 (JP) 2020-149081

(51) Int. Cl. H04L 29/12

(52) U.S. Cl. CPC H04L 61/106; H04L 61/2592

(57) ABSTRACT

A system includes a plurality of processing servers connected to a plurality of networks with different address systems. For each module that constitutes an application, a processing server at an arrangement destination of the module has tunneling transmission information. The tunneling transmission information is information representing a module address and a processing server address for each module. The processing server address is an address that follows an address system of a network to which the processing server is connected, while the module address is an address that follows an address system of a virtual network. The processing server specifies the processing server address of the processing server in which a module at a transmission destination of a packet is arranged from the tunneling transmission information, and transmits the packet based on the specified processing server address.

### BACKGROUND OF THE INVENTION

### 1. Field of the Invention

The present invention generally relates to an information processing technology.

### 2. Description of the Related Art

As a technology related to information processing, for example, there is edge computing. As the technology related to the edge computing, for example, there are technologies disclosed in JP2018-190124 and JP2019-144864. In the technology disclosed in JP2018-190124, a plurality of modules constituting an application is arranged on a plurality of data processing nodes. The technology disclosed in JP2019-144864 divides a model, which is a program for processing data, and assigns a plurality of division models to a plurality of edge servers.

### SUMMARY OF THE INVENTION

An environment in which a plurality of networks coexist has been known. As an example of such an environment, there is a factory. In the factory, for example, a plurality of networks such as control networks, information networks, and office networks coexist according to business requirements. These networks generally have different address systems (for example, different types of networks have different address configurations). In addition, there are various requirements such as a communication delay and a data distribution range depending on the business. When a system engineer is aware of these address systems and requirements, and sets up an application constituted by a plurality of modules that each performs input and output or sets up a system configuration (for example, a configuration of a server connected to a network and a configuration of the network itself), it is difficult to properly follow field environmental changes (for example, fluctuations in supply and demand or changes in processes) that occur frequently (for example, on the order of seconds or minutes). For example, the change in the field environment that cannot be dealt with by changing parameters of a request transmitted to a device to be controlled is considered, and it is not possible to follow the change in the field environment. In addition, for example, when the plurality of modules that constitute an appropriate application are arranged in the changed field environment, the address systems of each network are different, so the system engineer should manually set the address for each module.

It is predicted that the above-described problems will become more prominent when the network becomes wireless by introducing, for example, private LTE (LTE stands for long term evolution) or local 5G in the future. In addition, the above-described problems may also occur in environments other than the factory. In addition, the above-described problems may also occur in the information processing technology other than the engine computing.

A plurality of processing servers that are connected to a plurality of networks with a different address system and each have a physical interface device for network communication are provided. With respect to each of one or more applications, for each of a plurality of modules that constitute the applications and each input and output data, a processing server at an arrangement destination of the module has tunneling transmission information. The tunneling transmission information is information representing a module address and a processing server address for each of the plurality of modules. The module is arranged in the processing server at the arrangement destination. The module address is an address that follows an address system of a virtual network and is an address assigned to the module. The processing server address is an address of the processing server in which the module is arranged and is an address that follows the address system of the network to which the processing server is connected. The processing server in which the module is arranged specifies the processing server address of the processing server in which a module at a transmission destination of a packet is arranged from the tunneling transmission information configured in the processing server, and transmits the packet based on the specified processing server address.

According to the present invention, it is possible to set a system configuration including an application arrangement that appropriately follows the change in the field environment.

### BRIEF DESCRIPTION OF THE DRAWINGS

FIG. 1 is a diagram illustrating a configuration example of a processing system according to a first embodiment;

FIG. 2 is a configuration example of an orchestration server;

FIG. 3 is a diagram illustrating a configuration example of a processing server;

FIG. 4 is a diagram illustrating a configuration example of an application;

FIG. 5 is a diagram illustrating a configuration example of a metric table;

FIG. 6 is a diagram illustrating a configuration example of an application requirement table;

FIG. 7 is a diagram illustrating a configuration example of an application management table;

FIG. 8 is a diagram illustrating a configuration example of a tunneling transmission table;

FIG. 9 is a diagram illustrating a configuration example of an address conversion table;

FIG. 10 is a diagram illustrating a configuration example of a name resolving table;

FIG. 11 is a diagram illustrating a configuration example of a packet transmitted and received by the processing server;

FIG. 12 is a diagram illustrating an example of a flow of deployment processing;

FIG. 13 is an overview view illustrating a configuration of a plurality of processing servers after the deployment processing;

FIG. 14 is a diagram illustrating an example of a deployment processing result screen;

FIG. 15 is a diagram illustrating an example of a flow of communication processing after the deployment processing;

FIG. 16 is a diagram illustrating an example of the flow of the deployment processing;

FIG. 17 is a diagram illustrating a part of an example of the flow of the communication processing performed by the processing server;

FIG. 18 is a diagram illustrating a part of an example of the flow of the communication processing performed by the processing server;

FIG. 19 is a diagram illustrating the rest of an example of the flow of the communication processing performed by the processing server; and

FIG. 20 is a diagram illustrating a configuration example of a processing system according to a second embodiment.

### DESCRIPTION OF THE PREFERRED EMBODIMENTS

In the following description, an “interface device” may be one or more communication interface devices. One or more communication interface devices may be one or more similar communication interface devices (for example, one or more network interface cards (NICs)) or two or more of heterogeneous communication interface devices (for example, NICs and host bus adapter (HBA)).

Further, in the following description, a “memory” is one or more memory devices which are an example of one or more storage devices, and may be typically a main storage device. At least one memory device in the memory may be a volatile memory device or a non-volatile memory device.

Further, in the following description, a “permanent storage device” may be one or more permanent storage devices which are an example of one or more storage devices. The persistent storage device is typically a non-volatile storage device (for example, auxiliary storage device), specifically, for example, a hard disk drive (HDD), a solid state drive (SSD), a non-volatile memory express (MVNE) drive, or a storage class memory (SCM).

Further, in the following description, the “storage device” may be at least a memory of a memory and a permanent storage device.

Further, in the following description, a “processor” may be one or more processor devices. At least one processor device is typically a microprocessor device such as a central processing unit (CPU), but may be another type of processor device such as a graphics processing unit (GPU). At least one processor device may be single-core or multi-core. At least one processor device may be a processor core. At least one processor device may be a processor device in a broad sense such as a circuit (for example, field-programmable gate array (FPGA), complex programmable logic device (CPLD), or application specific integrated circuit (ASIC)) which is an aggregate of gate arrays by a hardware description language that performs a part or all of processing.

Further, in the following description, “xxx table” may be used to explain the information that can be obtained for the input, but the information may be data (for example, it may be structured data or unstructured data) of any structure, or may be a learning model represented by a neural network, a genetic algorithm, or a random forest that generates an output for an input. Therefore, the “xxx table” can be referred to as “xxx information”. Further, in the following description, the configuration of each table is an example, and one table may be divided into two or more tables, or all or a part of the two or more tables may be one table.

Further, in the following description, the function may be described by the expression of “yyy part”, but the function may be realized by executing one or more computer programs by the processor, or by one or more hardware circuits (for example, FPGA or ASIC), or by a combination thereof. When the function is realized by executing a program by a processor, the specified processing is appropriately performed by using a storage device and/or an interface device, or the like, so that the function may be at least a part of the processor. The processing described with the function as the subject may be processing performed by a processor or a device having the processor. The program may be installed from a program source. The program source may be, for example, a program distribution computer or a computer-readable recording medium (for example, a non-temporary recording medium). The description of each function is an example, and a plurality of functions may be combined into one function, or one function may be divided into a plurality of functions.

Further, in the following description, a common code among reference codes may be used when the same type of elements are not distinguished, and a reference code may be used when the same type of elements are distinguished.

Further, as the information for identifying the element, arbitrary information (for example, at least one of “ID”, “name”, and “number”) may be adopted.

Although the present invention can be applied to both wired communication and wireless communication, wireless communication is adopted in the following embodiments.

An example of wireless communication may include the 5th generation mobile communication (or long term evolution (LTE)). The 5th generation mobile communication (5G) can realize low-latency, wideband, and highly reliable wireless communication. Under such circumstances, local 5G (or private LTE), which introduces a 5G wireless network for self-employed networks, is drawing attention. As an example of the application of local 5G, application to factories can be considered. In the factory, for example, a plurality of networks such as control networks, information networks, and office networks coexist according to business requirements. These networks generally have different address systems, and therefore, when the factory network is formed wirelessly, different address systems will coexist. In addition, there are various requirements such as a communication delay and a data distribution range depending on the business. When the system engineer is aware of these address systems and requirements and sets up an application composed of a plurality of modules that perform input and output respectively, it is difficult to properly follow field environmental changes (for example, fluctuations in supply and demand or changes in processes) that occur frequently (for example, on the order of seconds or minutes).

Therefore, in the following embodiment, the plurality of processing servers are connected to the plurality of networks, the plurality of modules that constitute the application and each input and output data are arranged in the plurality of processing servers, and each module address of the plurality of modules follows the address system of the virtual network.

Hereinafter, some embodiments will be described.

### First Embodiment

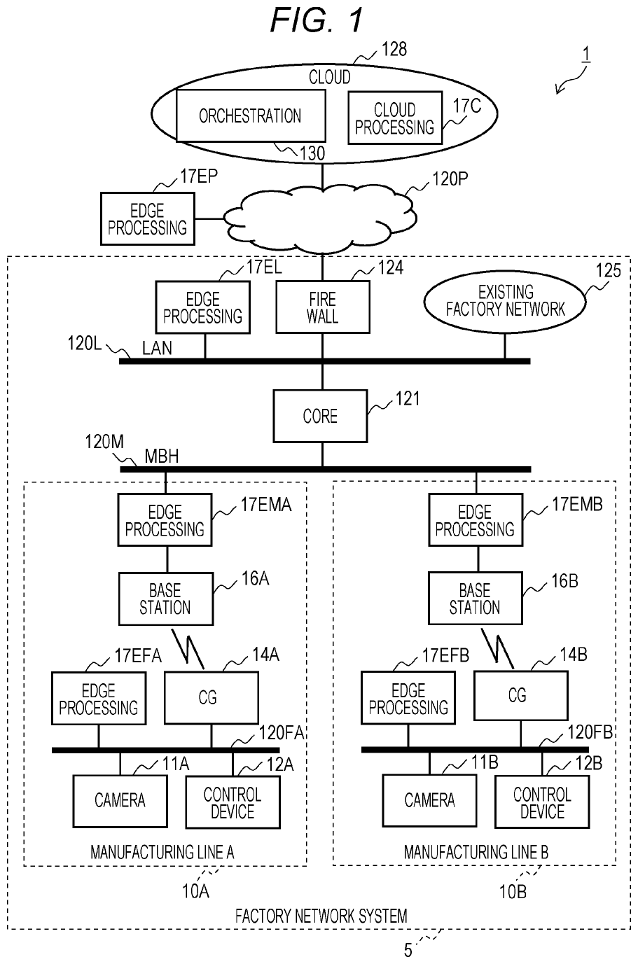

FIG. 1 illustrates a configuration example of a processing system according to a first embodiment.

A factory network system 5 is built. The factory network system 5 receives cloud computing services based on a cloud 128 through public carrier network 120P. An edge processing server 17EP is connected to the public carrier network 120P.

The factory network system 5 includes a production line 10 (10A and 10B), a mobile back haul (MBH) 120M, a mobile core device 121, a local area network (LAN) 120L, an edge processing server 17EL, a firewall 124, and an existing factory network 125. The edge processing server 17EL, the firewall 124, and the existing factory network 125 are connected to a LAN 120L. When a packet is transmitted/received to/from the edge processing server 17EP or the cloud 128 through the LAN 120, the packet passes through the firewall 124 and the public carrier network 120P.

The production line 10 includes a field network 120F, a camera 11, a control device 12, an edge processing server 17EF, a cellular gateway (CG) 14, a base station 16, and an edge processing server 17EM. In the production line 10, the camera 11, the control device 12, the edge processing server 17EF and the CG14 are connected to the field network 120F, and the edge processing server 17EF communicates with the edge processing server 17EM through the CG14 and the base station 16. Do. The CG14 is a device that performs wireless communication with the base station 16. The base station 16 may be called, for example, gNB (next generation Node B) (or evolved Node B (eNB) in LTE). The camera 11 photographs, for example, an object controlled by the control device 12 and its surroundings.

Examples of a plurality of networks include a field networks 120F, a MBH 120M, a LAN 120L and a public carrier network 120P. The field network 120F is a network to which devices such as the camera 11 and the control device 12 are connected. The MBH 120M is an example of a first network (a network connecting a core network and one or more base stations 16), and may be, for example, a network including a plurality of facilities owned by a mobile network operator (MNO) and may be a network constructed by a user. The LAN 120L is an example of the second network. The public carrier network 120P is a network provided by a telecommunications carrier. The mobile core device 121 intervenes between the MBH 120M and the LAN 120L. Packets transmitted and received between the MBH 120M and the LAN 120L pass through the mobile core device 121. The mobile core device 121 is at least a part of the core network. The mobile core device 121 is, for example, a 5G core network (or evolved packet core (EPC)).

The processing system 1 includes a plurality of processing servers 17 and an orchestration server 130 (an example of a management server) in which a plurality of modules constituting an application are arranged in the plurality of processing servers 17.

As an example of a processing server 17, there is each of a plurality of edge processing servers 17E connected to the plurality of networks 120. The edge processing server 17E may be, for example, multi-access edge computing (MEC). As the edge processing server 17E, there are the edge processing server 17EF connected to the field network 120F, the edge processing server 17EM connected to the MBH 120M, the edge processing server 17EL connected to the LAN 120L, and the edge processing server 17EP connected to the public carrier network 120P. Further, as an example of the processing server 17, there is a cloud processing server 17C which is a processing server based on the cloud 128.

The orchestration server 130 is a server based on the cloud 128, but may be another type of server, for example, an on-premises server.

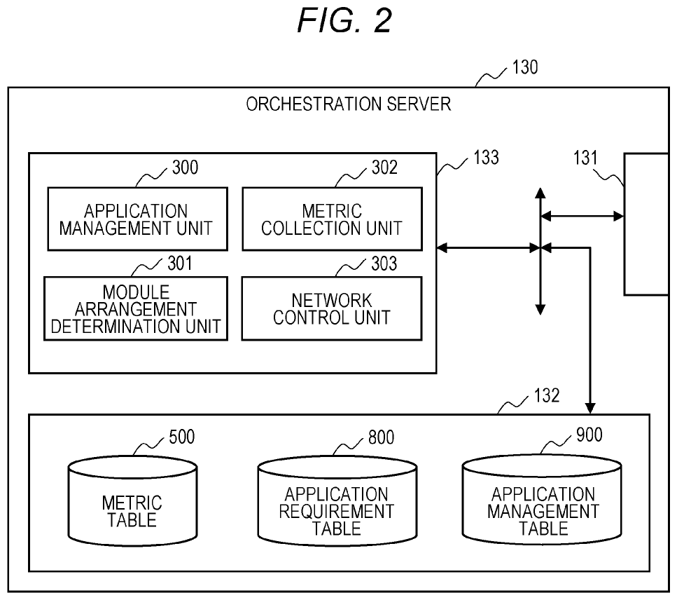

FIG. 2 illustrates a configuration example of the orchestration server 130.

The orchestration server 130 is realized based on a plurality of types of physical hardware resources such as an interface device 131, a storage device 132, and a processor 133 connected thereto. Data is transmitted and received through the interface device 131. The storage device 132 stores information and programs. Examples of information stored in the storage device 132 include a metric table 500, an application requirement table 800 and an application management table 900. When the processor 133 executes the program in the storage device 132, an application management unit 300, a module arrangement determination unit 301, a metric collection unit 302, and a network control unit 303 are realized.

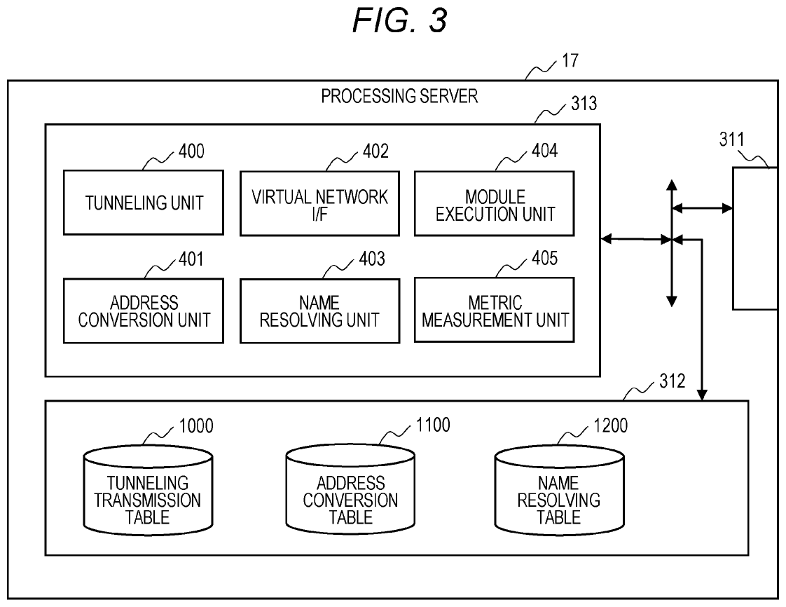

FIG. 3 is a diagram illustrating a configuration example of the processing server 17.

The processing server 17 is realized based on a plurality of types of physical hardware resources such as an interface device 311, a storage device 312, and a processor 313 connected thereto. Packets are transmitted and received through the interface device 311. The storage device 312 stores information and programs. Examples of information stored in storage 312 include a tunneling transmission table 1000, an address conversion table 1100, and a name resolving table 1200. These tables 1000, 1100, and 1200 are tables that are stored or deleted from the orchestration server 130. When the processor 313 executes the program in the storage device 312, a tunneling unit 400, an address conversion unit 401, a virtual network interface (I/F) 402, a name resolving unit 403, a module execution unit 404, and a metric measurement unit 405 are realized. The virtual network I/F 402 is dynamically created or deleted. The processor 313 includes one or more CPU cores.

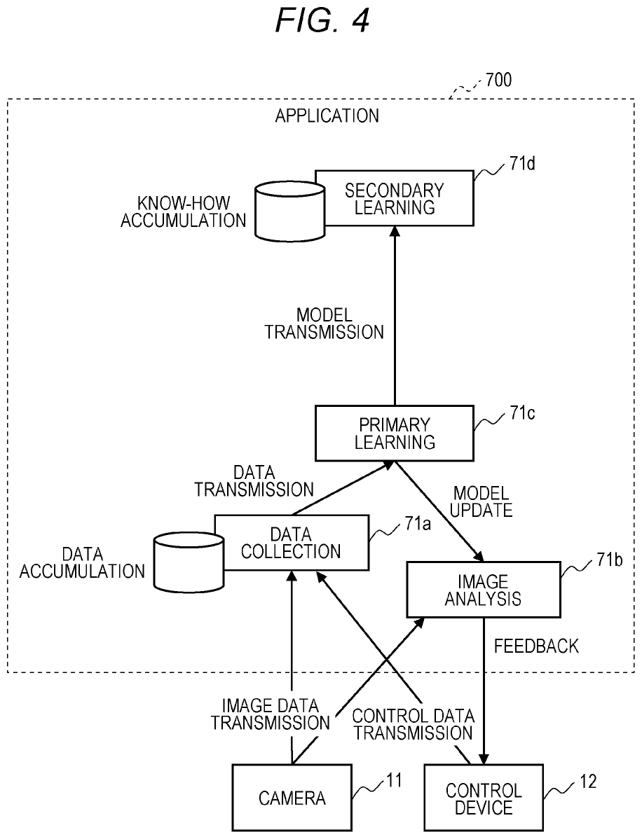

FIG. 4 illustrates a configuration example of an application.

The application 700 is constituted by a plurality of modules 71, each of which inputs and outputs data. The module 71 may be a node (or a program called by the node) prepared by using a visual programming tool, or a program called through an application programming interface (API). Examples of the module 71 include a module that performs data communication with another module 71 and a module that performs data communication with a device in addition to another module 71.

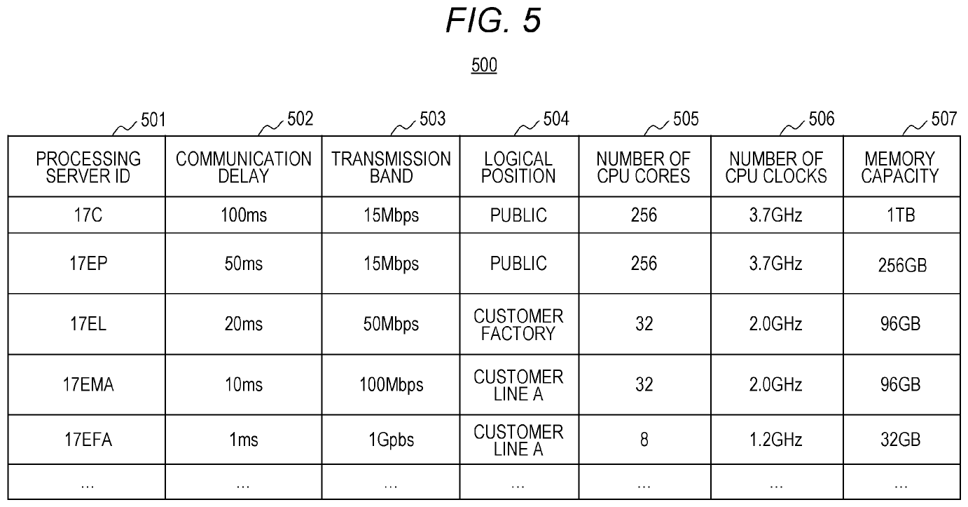

After FIG. 5, an application 700 illustrated in FIG. 4 is taken as an example as appropriate. The application 700 illustrated in FIG. 4 is as follows. That is, the application 700 includes a data acquisition module 71a, a video analysis module 71b, a primary learning module 71c, and a secondary learning module 71d. These modules 71a to 71d are examples of the plurality of modules 71. The data collection module 71a collects video data (video data taken by the camera 11) from the camera 11, control data (data transmitted by the control device 12 for control) from the control device 12, stores the collected data (video data and control data) in the storage device, or transmits the collected data to the primary learning module 71c. The video analysis module 71b receives video data from the camera 11, analyzes the video data using an analysis model (learning model for video analysis), and feeds back the analysis result to the control device 12. The primary learning module 71c receives data from the data collection module 71a, learns the analysis model based on the received data, updates the analysis model used by the video analysis module 71b to the analysis model after training, and transmits the trained model to the secondary learning module 71d. The secondary learning module 71d stores the learning model from the primary learning module 71c in the storage device, and stores the information obtained by performing the secondary learning based on one or more accumulated learning models in the storage device as know-how.

FIG. 5 illustrates a configuration example of a metric table 500.

The metric table 500 is a table in which the metric values collected from the processing server 17 are registered. The metric table 500 has an entry for each processing server 17, for example. Each entry holds information such as a processing server ID 501, a communication delay 502, a communication band 503, a logical position 504, the number of CPU cores 505, the number of CPU clocks 506, and a memory capacity 507. One processing server is taken as an example (“processing server of interest” in the explanation of FIG. 5).

The processing server ID 501 represents the ID of the processing server 17 of interest (in the present embodiment, the ID of the processing server and the reference code are the same). The communication delay 502 represents a delay time of communication from the processing server 17 of interest to the control device 12. The communication band 503 represents the communication band from the processing server 17 of interest to the camera 11. The logical position 504 represents a label (name) of the logical position of the processing server 17 of interest. The number of CPU cores 505 represents the number of CPU cores in use (allocated) in the processing server 17 of interest. The number of CPU clocks 506 represents the number of CPU clocks in the processing server of interest. The memory capacity 507 represents the amount of memory in use in the processing server 17 of interest.

The metric values represented by each of the communication delay 502, the communication band 503, the number of CPU cores 505, the number of CPU clocks 506, and the memory capacity 507 are measured by the metric measurement unit 405 of the processing server 17, and is the metric value collected from each processing server 17 by the metric collection unit 302 of the orchestration server 130. The orchestration server 130 may manage a server management table (not illustrated) representing the specifications of each processing server 17 (for example, the number of CPU cores, the number of CPU clocks, the amount of memory, or the like). The orchestration server may specify the amount of free resources for each processing server 17 from the difference between the specifications of the processing server 17 and the collected metric values.

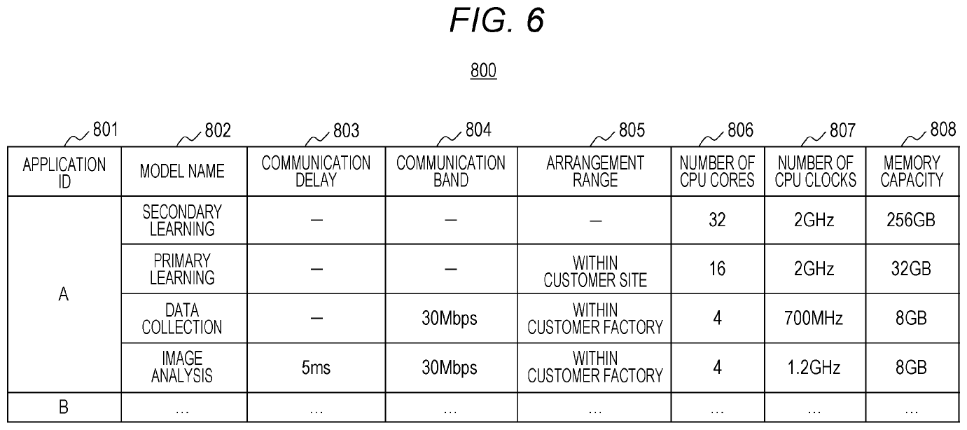

FIG. 6 illustrates a configuration example of the application requirement table 800.

The application requirement table 800 represents the requirements for each application. The application requirement table 800 has, for example, an entry for each application. Each entry holds information such as an application ID 801, a module name 802, a communication delay 803, a communication band 804, an arrangement range 805, the number of CPU cores 806, the number of CPU clocks 807, and the amount of memory 808. One application is taken as an example (“application of interest” in the explanation of FIG. 6).

The application ID 801 represents the ID of the application of interest. The module name 802 represents the name of each of the plurality of modules that constitute the application of interest. One module is taken as an example (“module of interest” in the explanation of FIG. 6). The information 803 to 808 represent the requirements for the module of interest. The communication delay 803 represents the delay time of communication from the module of interest to the control device 12. The communication band 804 represents the communication band from the module of interest to the camera 11. The arrangement range 805 represents a range of a position where the module of interest is arranged. The number of CPU cores 806 represents the number of CPU cores required to execute the module of interest. The number of CPU clocks 807 represents the number of CPU clocks required to execute the module of interest. The amount of memory 808 represents the amount of memory required to execute the module of interest.

The above-described server management table (not illustrated) managed by the orchestration server 130 may represent the positions of each processing server. For each processing server, it may be possible to determine whether or not the position of the processing server satisfies the arrangement position 804.

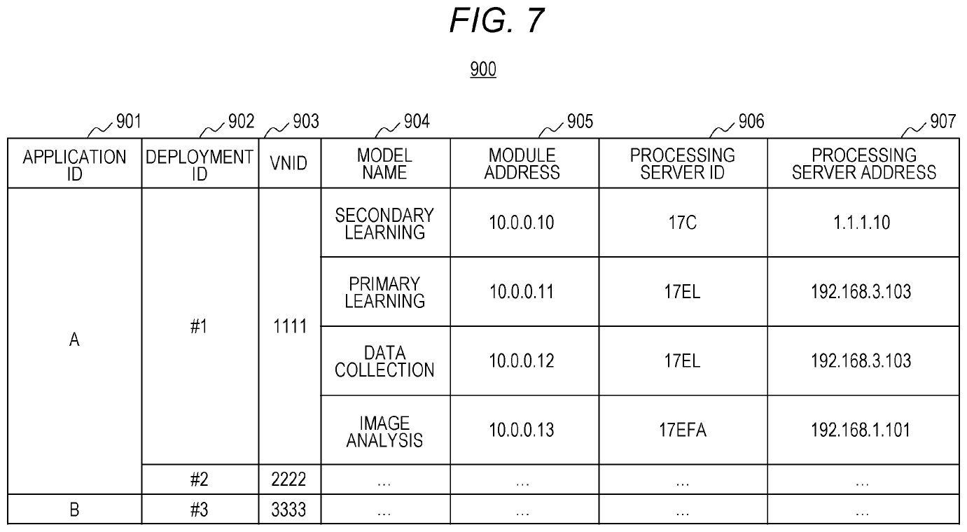

FIG. 7 illustrates a configuration example of the application management table 900.

The application management table 900 represents a determined arrangement destination for each module for each application. The application management table 900 has, for example, an entry for each application. Each entry holds information such as an application ID 901, a deployment ID 902, a VNID 903, a module name 904, a module address 905, a processing server ID 906, and a processing server address 907. One application is taken as an example (“application of interest” in the explanation of FIG. 7).

The application ID 901 represents the ID of the application of interest. The deployment ID 902 represents the deployment ID of the application of interest. The VNID 903 represents the ID of the virtual network used for communication by each module constituting the application of interest. The module name 904 represents the name of each of the plurality of modules that constitute the application of interest. One module is taken as an example (“module of interest” in the explanation of FIG. 7). The module address 905 represents the module address of the module of interest. The processing server ID 906 represents the ID of the processing server 17 at the arrangement destination of the module of interest. The processing server address 907 represents the processing server address of the processing server 17 of the arrangement destination of the module of interest.

Here, for each module, the “module address” is an address according to the address system of the virtual network used by the module for communication, and is an address assigned to the module. For the plurality of modules belonging to the same virtual network, the module address may be automatically assigned by, for example, the orchestration server 130.

In addition, for each module, the “processing server address” of the processing server 17 in which the module is arranged is the address of the processing server 17 and is an address according to the address system of the network 120 to which the processing server 17 is connected.

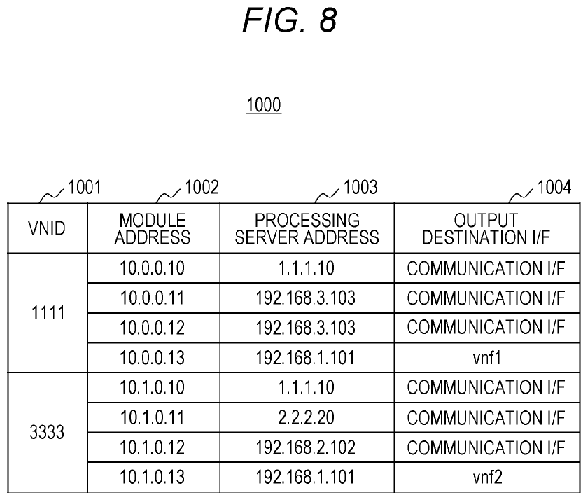

FIG. 8 illustrates a configuration example of a tunneling transmission table 1000.

The tunneling transmission table 1000 represents the module address and the processing server address for each of the plurality of modules. The tunneling transmission table 1000 has an entry for each module, for example. Each entry holds information such as a VNID 1001, a module address 1002, a processing server address 1003, and an output destination I/F 1004. One module is taken as an example (“module of interest” in the explanation of FIG. 8).

The VNID 1001 represents the ID of the virtual network to which the module of interest belongs. The module address 1002 represents the module address of the module of interest. The processing server address 1003 represents the processing server address of the transmission destination when the module address of the module of interest is a transmission source or a transmission destination. An output destination I/F 1004 represents the interface of the output destination of the packet when the module address of the module of interest is the transmission source or the transmission destination. The “communication I/F” means the physical interface device 311 of the processing server 17 in which the module of interest is arranged. “Vnf1” or “vnf2” represent (name of) the virtual network I/F 402.

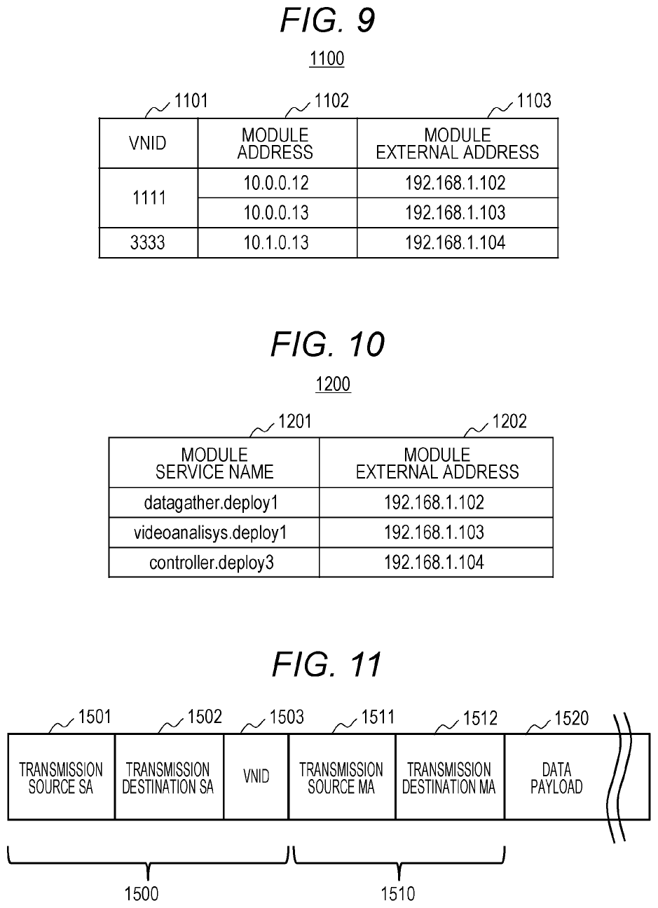

FIG. 9 illustrates a configuration example of the address conversion table 1100.

The address conversion table 1100 shows the correspondence between the module address of the module and the module external address (the address of the module for external communication for communicating with the device). The address conversion table 1100 has an entry for each module that communicates with the device, for example. Each entry holds information such as a VNID 1101, a module address 1102, and a module external address 1103. One module is taken as an example (“module of interest” in the explanation of FIG. 9).

The VNID 1101 represents the ID of the virtual network to which the module of interest belongs. The module address 1102 represents the module address of the module of interest. The module external address 1103 represents an address for external communication for the module of interest to communicate with the device.

FIG. 10 illustrates a configuration example of a name resolving table 1200.

The name resolving table 1200 represents the correspondence between the service name of the module and the external address of the module. The name resolving table 1200 has an entry for each module that communicates with the device, for example. Each entry holds information such as a module service name 1201 and a module external address 1202. One module is taken as an example (“module of interest” in the explanation of FIG. 10).

The module service name 1201 represents a service name of the module of interest. The module external address 1202 represents an address for external communication for the module of interest to communicate with the device.

FIG. 11 illustrates a configuration example of packets sent and received by the processing server 17.

The packet transmitted and received by the processing server 17 is a packet in which an outer header 1500 is added to a packet including a data payload 1520 and an inner header 1510.

The data payload 1520 is data transmitted or received by the module of the transmission source or transmission destination. The inner header 1510 includes a transmission source MA 1511 and a transmission destination MA 1512. The transmission source MA 1511 is the module address of the module of the transmission source. The transmission destination MA 1512 is the module address of the module of the transmission destination. The module is designed to transmit and receive a packet including the inner header 1510 and the data payload 1520.

The outer header 1500 includes a transmission source SA1501, a transmission destination SA1502, and a VNID 1503. The transmission source SA1501 is the processing server address of the processing server of the transmission source. The transmission destination SA 1502 is the processing server address of the processing server of the transmission destination. The VNID 1503 is the ID of the virtual network. The outer header 1500 is added or deleted by the tunneling unit 400.

Hereinafter, an example of the processing performed in the present embodiment will be described.

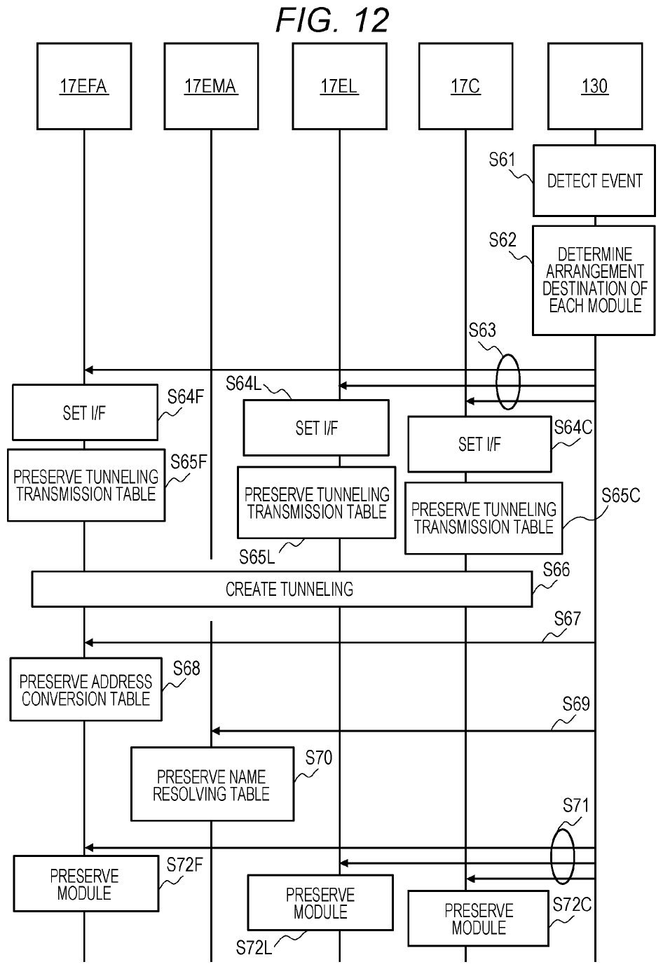

FIG. 12 illustrates an example of the flow of the deployment processing.

The application management unit 300 of the orchestration server 130 detects the event of the start of the deployment processing (S61). When the event is detected, processes after S62 will be performed.

The event may receive a request for deployment processing from a user (for example, a client terminal of the orchestration server 130). As a result, the deployment processing is performed at a user's arbitrary timing. Note that the ID of the application to be arranged may be designated in the request, and the application corresponding to the designated ID may be arranged in the plurality of processing servers 17 in the deployment processing.

In addition, the event may be in a state in which the state of the environment to be monitored corresponds to the un-deployed application. Specifically, for example, the orchestration server 130 may hold a table that represents the environmental state corresponding to the application for each application. When the application management unit 300 detects that the state of the environment to be monitored corresponds to the state corresponding to the un-deployed application based on the table, the application may be determined as the deployment target. As a result, it is expected that appropriate applications will be automatically deployed in response to the changes in environmental state.

As an example of “the state of the environment to be monitored corresponds to the un-deployed application”, the metric value (metric values of various metrics collected from each processing server 17 by the metric collection unit 302 of the orchestration server 130) specified from the metric table 500 may correspond to the metric value range corresponding to the un-deployed application. As a result, it is expected that a more appropriate application will be automatically deployed and implemented in place of the deployed application.

When the above-described event is detected, the module arrangement determination unit 301 determines the processing server of the arrangement destination of the module for each of the plurality of modules that constitute the application of the deployment target, and adds the entry of the module to the application management table 900 (S62). In S62, for example, the module arrangement determination unit 301 performs the following processing.
The module arrangement determination unit 301 specifies the position and the amount of free resources of the each processing server based on the specifications of the processing server and the information 502 to 507 for the processing server based on the metric table 500.
For each of the plurality of modules that constitute the deployment target application, the module arrangement determination unit 301 specifies the processing server corresponding to the position and the amount of free resources that meet the requirements (information 803 to 808 specified from the application requirement table 800) of the module, and determines the specified processing server as the arrangement destination of the module.
The module arrangement determination unit 301 determines the ID of the virtual network of the plurality of modules that constitute the application of the deployment target. The module arrangement determination unit 301 assigns a module address according to the address system of the virtual network for each of the plurality of modules.
The module arrangement determination unit 301 adds the entry (information 901 to 907) of the module to the application management table 900 for each of the plurality of modules constituting the application of the deployment target.

As a result of S62, in the following description, it is assumed that the application of the deployment target is the application 700 illustrated in FIG. 4, and the arrangement destinations of the modules 71a to 71d are determined as illustrated in FIG. 7. That is, an arrangement destination of a data collection module 71a and a primary learning module 71c is an edge processing server 17EL, the arrangement destination of the video analysis module 71b is an edge processing server 17EFA, and an arrangement destination of a secondary learning module 71d is a cloud processing server 17C.

The network control unit 303 specifies the processing server 17 at the arrangement destination of each arrangement of modules 71a to 71d constituting the application 700 from the application management table 900, and transmits the tunneling transmission table 1000 for the processing server 17 to the processing server 17 (S63). For example, the tunneling transmission table 1000 for the edge processing server 17EFA is the table 1000 as illustrated in FIG. 8. That is, the output destination I/F 1004 corresponding to the video analysis module 71b (module address “10.0.0.13”) is “vnf1”, and the output destination I/F 1004 corresponding to the remaining modules 71a, 71c, and 71d is the “communication I/F”.

In each of the processing servers 17EFA, 17EL, and 17C that received the tunneling transmission table 1000, the tunneling unit 400 sets the virtual network I/F 402 of the module 71 based on the tunneling transmission table 100 (S64F, S64L, and S64C). The module address of the module corresponding to the virtual network I/F 402 is associated with the virtual network I/F. In each of the processing servers 17EFA, 17EL, and 17C, the tunneling unit 400 stores the received tunneling transmission table 1000 (S65F, S65L, and S65C).

Thereafter, the tunneling is created by the tunneling unit 400 in each of the processing servers 17EFA, 17EL, and 17C (S610). The “tunneling” referred to in this paragraph may be, for example, a virtual eXtensible local area network (VXLAN), a network virtualization using generic routing encapsulation (NVGRE), stateless transport tunneling (STT), or the like. S610 may be optional processing. Further, the “virtual network” referred to in this embodiment may be a virtual network on the VXLAN.

The network control unit 303 of the orchestration server 130 transmits the address conversion table 1100 to the edge processing server 17EFA connected to the same network 120FA as the camera 11A and the control device 12A (S67). In each of the edge processing servers 17EFA, the address conversion unit 401 saves the address conversion table 1100 (S68).

There is a device communication module in modules 71a to 71d, and packets entering and exiting the production line 10A including the camera 11A and the control device 12A always pass through the edge processing server 17EMA connected to the MBH 120M. To such an edge processing server 17EMA, the network control unit 303 transmits to the name resolving table 1200 (S69). On the edge processing server 17EMA, the name resolving unit 403 stores the name resolving table 1200 (S70).

The network control unit 303 transmits the modules 71a to 71d constituting the application 700 to the processing servers 17EFA, 17EL and 17C of the specified arrangement destination (S71). In each of the processing servers 17EFA, 17EL, and 17C, the module execution unit 404 saves and starts the module 71 (S72F, S72L, and S72C). The module execution unit 404 executes the module 71.

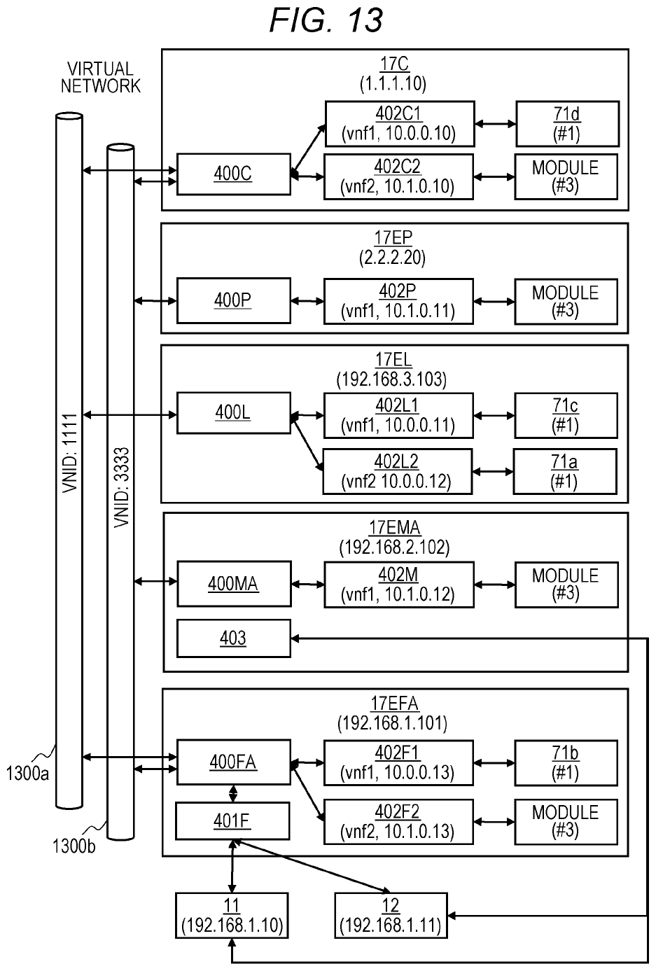

FIG. 13 is an overview view illustrating a configuration of a plurality of processing servers 17 after the deployment processing. In FIG. 13, “#n” (n is a natural number) in the module represents the deployment ID. Further, in FIG. 13, among the plurality of modules, each module constituting the example application 700 in FIG. 4 is indicated by a reference code.

For each deployment processing, there is a virtual network 1300. Specifically, there are a virtual network 1300a corresponding to deployment ID “#1” and a virtual network 1300b corresponding to deployment ID “#3”.

A virtual network I/F 402 is set in each processing server 17 for each module arranged in the processing server 17, the module address of the module is associated with the virtual network I/F, and the virtual network I/F 402 is interposed between the tunneling unit 400 and the module. For each module, the execution environment of the module may be an environment such as a virtual machine or a container. Each module transmits and receives data through the virtual network I/F 402 corresponding to the module. Each virtual network I/F 402 transmits and receives a packet including an inner header and data transmitted and received by a module corresponding to the virtual network I/F 402. The tunneling unit 400 adds or deletes the outer header to or from the packet including the inner header and data based on the tunneling transmission table 1000.

The virtual network corresponding to the deployment ID of the module arrangement is used for communication of packets including data transmitted and received by the module. The communication between the modules belonging to different virtual networks is not possible, and therefore, security can be maintained when the deployment processing is performed for each security range (segment in which the plurality of modules are arranged). For example, when the deployment processing of the module on the production line 10A and the deployment processing of the module on the production line 10B are performed separately, an independent virtual network is provided for each of the production lines 10A and 10B, and as a result, it is possible to avoid a mixture of data on the production line 10A and data on the production line 10B. Note that the modules arranged in one deployment processing may be some modules of one application or may be all modules of a plurality of applications.

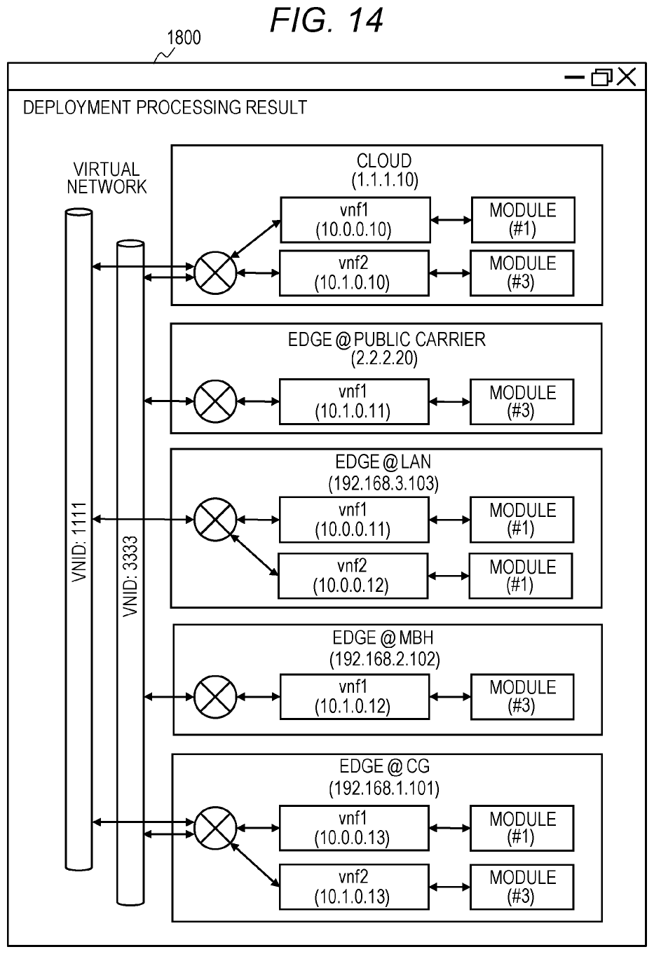

The deployment result illustrated in FIG. 13 is the result of deployment processing according to an application management table 900. The application management unit 300 of the orchestration server 130 may display a deployment processing result screen 1800 of an example of FIG. 14 to a user (for example, the client terminal of the orchestration server 130) based on the application management table 900. The deployment processing result screen 1800 represents which module and virtual network I/F are set in which processing server and which virtual network is used for which module. By including the same number in the VNID and the deployment ID, it may be possible to visually identify which module uses which virtual network.

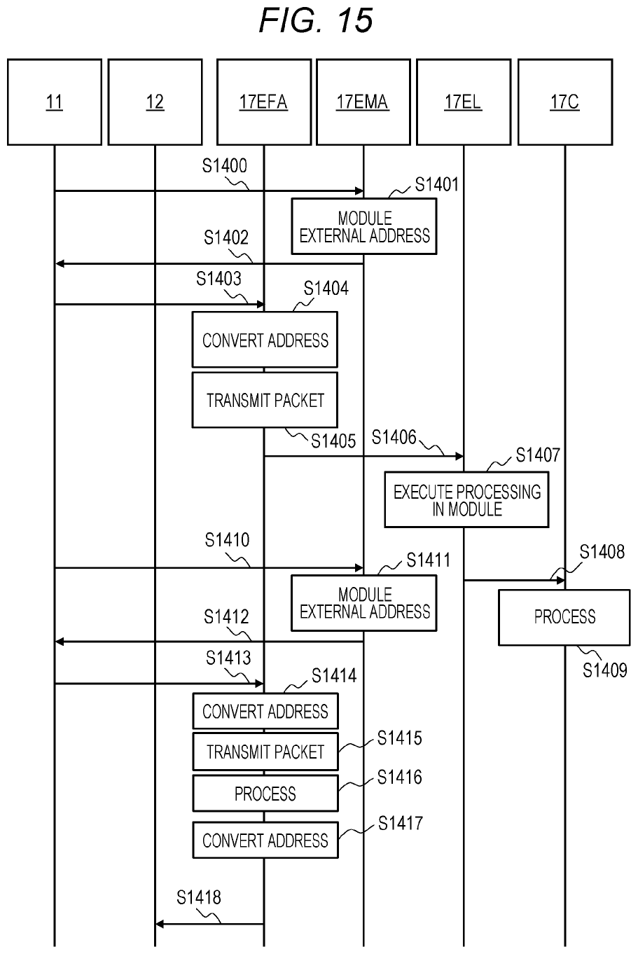

FIG. 15 illustrates an example of the flow of communication processing after deployment processing.

FIG. 15 illustrates the following (case A) and (case B).

(A) A case where the address destination of the data from the camera 11A is a module 71a.

(B) A case where the address destination of the data from the camera 11A is a module 71b.

The flow of (case A) is as follows, for example. The camera 11 attempts to transmit data to the module 71a. The module 71a may be designated by either the service name of the module or the external address. Herein, the module 71a is designated by the module service name. To communicate with the module 71a, the camera 11 designates the module service name (for example, “datagather.deploy1”) and transmits a name resolving query The name resolving unit 403 of the edge processing server 17EMA receives, from the camera 11, the name resolving query that designates the module service name of the module 71a (S1400). The name resolving unit 403 specifies the module external address corresponding to the module service name from the name resolving table 1200 (S1401), and transmits a response including the specified module external address to the camera 11 (S1402). A tunneling unit 400FA of the edge processing server 17EFA receives a packet including video data from the camera 11 that has been notified of the module external address (S1403). The address conversion unit 401 of the edge processing server 17EFA converts the module external address designated as the transmission destination in the packet into the module address of the module 71a based on the address conversion table 1100 (S1404), and the tunneling unit 400FA transmits a packet addressed to the module address (S1405). Since the module 71a is arranged in the edge processing server 17EL, a tunneling unit 400L of the edge processing server 17EL receives the packet (S1406). The module 71a processes data in the packet, the module 71a transmits the packet including the data to the module 71c in the edge processing server 17EL, and the module 71c processes the data in the packet (S1407). The edge processing server 17EL transmits the packet including the data transmitted by the module 71c to the cloud processing server 17C in which the module 71d is arranged, and the tunneling unit 400C of the cloud processing server 17C receives the packet (S1408). The module 71d in the cloud processing server 17C processes the data in the packet (S1409).

The flow of (case B) is as follows, for example. The camera 11 attempts to transmit data to the module 71b. The module 71b may be designated by either the service name of the module or the external address as in case A. Herein, the module 71b is designated by the module service name. To communicate with the module 71b, the camera 11 designates the module service name (for example, “videoanalisys.deploy1”) and transmits the name resolving query. The name resolving unit 403 of the edge processing server 17EMA receives, from the camera 11, the name resolving query that designates the module service name of the module 71b (S1410). The name resolving unit 403 specifies the module external address corresponding to the module service name from the name resolving table 1200 (S1411), and transmits a response including the specified module external address to the camera 11 (S1412). The tunneling unit 400FA of the edge processing server 17EFA receives a packet including video data from the camera 11 that has been notified of the module external address (S1413). The address conversion unit 401 of the edge processing server 17EFA converts the module external address designated as the transmission destination in the packet into the module address of the module 71b based on the address conversion table 1100 (S1414), and the tunneling unit 400FA transmits a packet addressed to the module address (S1415). The module 71b processes the data in the packet, and the module 71b transmits the packet addressed to the control device 12A (S1416). The tunneling unit 400FA receives the packet, and the address conversion unit 401 converts the module address, which is the transmission source in the packet, into the module external address based on the address conversion table 1100 (S1417). The tunneling unit 400FA transmits a packet to the device address (S1418).

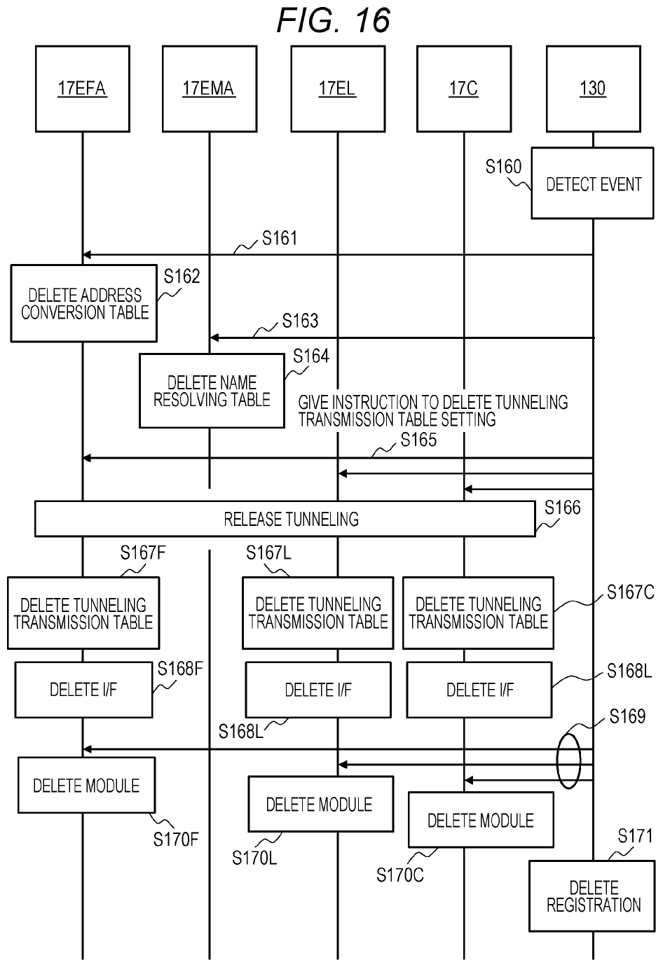

FIG. 16 illustrates an example of the flow of un-deployment processing.

The application management unit 300 of the orchestration server 130 detects a start event of the un-deployment processing (S160). When the event is detected, processes after S161 will be performed.

The event may receive a request for the un-deployment processing from a user (for example, a client terminal of the orchestration server 130). As a result, the un-deployment processing is performed at a user's arbitrary timing. Note that the ID of the application to be deleted may be designated in the request, and the application corresponding to the designated ID may be deleted from the plurality of processing servers 17 in the un-deployment processing.

Further, the event may be a state in which the state of the environment to be monitored does not correspond to the existing application. Specifically, for example, the application management unit 300 may determine, as an application to be deleted, an application in which the application that is the deployment target is arranged instead in the deployment processing that does not correspond to the state of the monitored environment among the existing applications. As a result, it is expected that inappropriate applications will be automatically deleted in response to the changes in environmental state. Whether or not the state of the environment to be monitored corresponds to the existing application may be based on, for example, the requirements of each module constituting the application and the amount of free resources of the processing server in which the module is arranged.

Here, for the sake of clarity, it is assumed that the application to be deleted is the application 700 illustrated in FIG. 4 and the application deployed by the deployment processing illustrated in FIG. 12.

When the above-described event is detected, the application management unit 300 requests the edge processing server 17EFA in which the address conversion table 1100 is set to delete the address conversion table 1100 (S161). In response to the request, the address conversion unit 401 of the edge processing server 17EFA deletes the address conversion table 1100 from the edge processing server 17EFA (S162).

The application management unit 300 requests the edge processing server 17EMA in which the name resolving table 1200 is set to delete the name resolving table 1200 (S163). In response to the request, the name resolving unit 403 of the edge processing server 17EMA deletes the name resolving table 1200 from the edge processing server 17EMA (S164).

The application management unit 300 requests the processing servers 17EFA, 17EL, and 17C in which the tunneling transmission table 1000 is set (at least one of the modules 71a to 71d is set) to delete the tunneling transmission table 1000 (delete the part corresponding to the application 700 to be deleted) (S165). In the request, for example, the name or module address of the application to be deleted and the name of the virtual network I/F to be deleted may be designated. In response to this request, the tunneling is deleted (S166). In each of the processing servers 17EFA, 17EL and 17C, the tunneling unit 400 deletes the tunneling transmission table 1000 from the processing server 17 (S167F, S167L, and S167C) and deletes the virtual network I/F 402 (S168F, S168L, and S168C).

The application management unit 300 requests the processing servers 17EFA, 17EL, and 17C to delete the module (S165). For example, the name or module address of the application to be deleted may be designated in the request. In response to the request, in each of the processing servers 17EFA, 17EL, and 17C, the module execution unit 404 stops the module 71 to be deleted and deletes the module 71 (S170F, S170L, and S170C).

The application management unit 300 deletes the entry corresponding to the application to be deleted from the application management table 900 (S171).

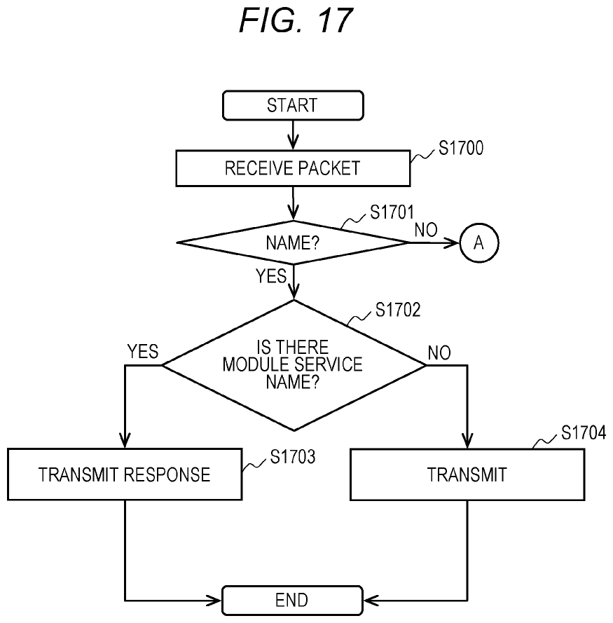

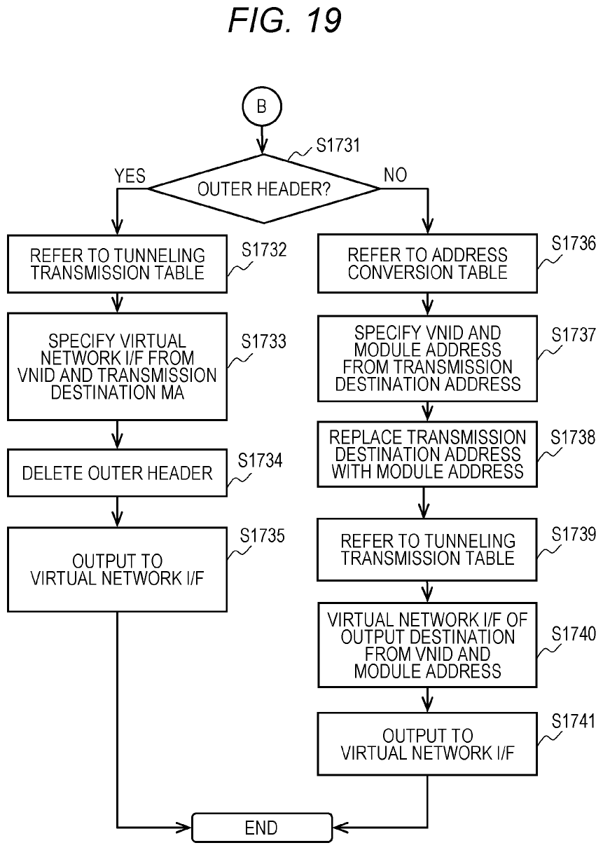

FIGS. 17, 18 and 19 illustrate an example of the flow of communication processing performed by the processing server 17. One processing server 17 is taken as an example (“processing server 17 of interest” in the explanation of FIGS. 17 to 19).

As illustrated in FIG. 17, the tunneling unit 400 receives a packet (S1700). The tunneling unit 400 determines whether or not the received packet is the name resolving query (S1701).

When the determination result of S1701 is true (S1701: Yes), the tunneling unit 400 determines whether or not the module service name designated in the name resolving query exists in the name resolving table 1200 (S1702).

If the determination result of S1702 is true (S1702: Yes), the packet is the name resolving query for the module, so the tunneling unit 400 specifies the module external address corresponding to the module service name from the name resolving table 1200 and transmits a response including the specified module external address (S1703). In this way, for communication with an external device, an address (typically an IP address) capable of communicating with the external device can be assigned to the module.

When the determination result of S1702 is false (S1702: No), the packet is a normal name resolving query, so the tunneling unit 400 transmits the packet as it is via the interface device 311 of the processing server 17 of interest (S1704).

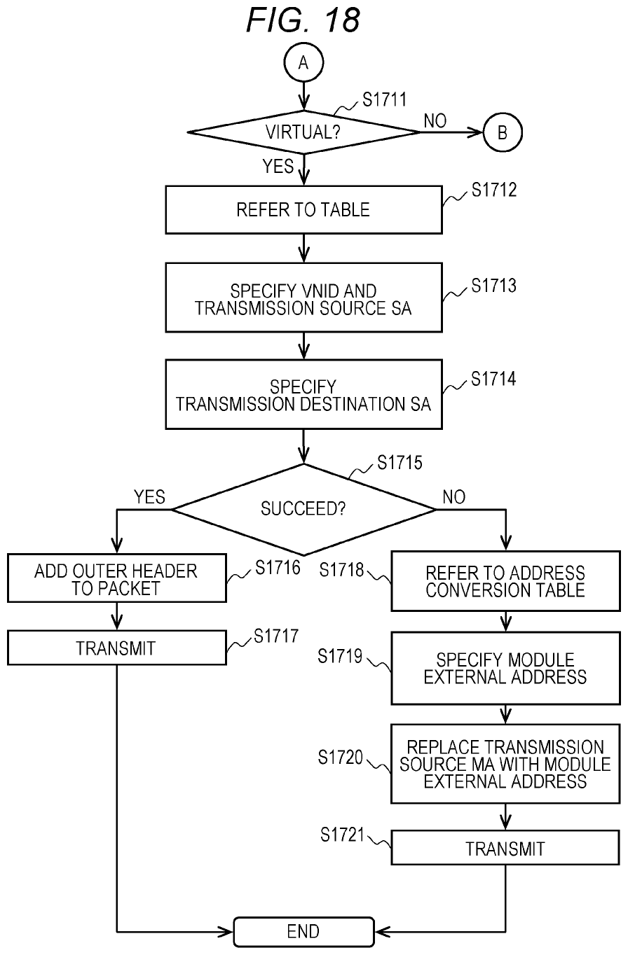

When the determination result of S1701 is false (S1701: No), as illustrated in FIG. 18, the tunneling unit 400 determines whether or not the interface through which the packet received by S1700 has passed is the virtual network I/F 402 (S1711).

When the determination result of S1711 is true (S1711: Yes), the tunneling unit 400 refers to the tunneling transmission table 1000 (S1712). The tunneling unit 400 specifies the VNID 1001 and the processing server address 1003 (the processing server address of the transmission source) corresponding to the name of the virtual network I/F from the tunneling transmission table 1000 (S1713). Then, the tunneling unit 400 specifies the processing server address (the processing server address of the transmission destination) corresponding to the module address of the transmission destination represented by the inner header in the received packet and the VNID specified in S1713 from the tunneling transmission table 1000 (S1714). The tunneling unit 400 determines whether or not S1714 is successful, that is, whether or not the processing server address of the transmission destination can be specified (S1715).

When the determination result of S1715 is true (S1715: Yes), the packet is a data communication packet transmitted between the modules, so the tunneling unit 400 adds the outer header including the processing server address of the transmission source specified in S1713 and the processing server address of the transmission destination specified in S1714 to the packet received in S1700 (S1716). The tunneling unit 400 transmits the packet to which the outer header is added via the interface device 311 of the processing server 17 of interest (S1717).

When the determination result of S1715 is false (S1715: No), the packet is a data communication packet transmitted to an external device, so the tunneling unit 400 refers to the address conversion table 1100 (S1718). The tunneling unit 400 specifies the module external address corresponding to the module address of the transmission source in the received packet and the VNID specified in S1713 from the address conversion table 1100 (S1719). The tunneling unit 400 replaces the module address of the transmission source in the received packet with the module external address specified in S1719 (S1720). The tunneling unit 400 transmits the packet via the interface device 311 of the processing server 17 of interest (S1721).

When the determination result of S1711 is false (S1711: No), that is, when the interface through which the packet received in S1700 has passed is the interface device 311 of the processing server 17 of interest, the tunneling unit 400 determines whether or not the outer header is present in the packet (S1731).

When the determination result of S1731 is true (S1731: Yes), so the packet is a data communication packet received between the modules, so the tunneling unit 400 refers to the tunneling transmission table 1000 (S1732). The tunneling unit 400 specifies the name of the virtual network I/F corresponding to the VNID represented by the outer header in the packet and the module address of transmission destination represented by the inner header in the packet from the tunneling transmission table 1000 (S1733). The tunneling unit 400 deletes the outer header from the packet (S1734). The tunneling unit 400 outputs the packet from which the outer header has been deleted to the virtual network I/F 402 specified in S1733 (S1735).

When the determination result of S1731 is false (S1731: No), the packet is the data communication packet received from the packet, so the tunneling unit 400 refers to the address conversion table 1100 (S1736). The module external address for communicating between the external device and the module is designated in the transmission destination address of the packet. The tunneling unit 400 specifies the VNID and the module address corresponding to the transmission destination address designated in the packet from the address conversion table 1100 (S1737). The tunneling unit 400 replaces the transmission destination address of the packet with the module address specified in S1737 (S138). The tunneling unit 400 refers to the tunneling transmission table 1000 (S1739). The tunneling unit 400 specifies the name of the virtual network I/F corresponding to the VNID specified in S1737 and the module address after replacement of S1738 from the tunneling transmission table 1000 (S1740). The tunneling unit 400 outputs the packet to the virtual network I/F 402 specified in S1740 (S1741).

The above is the description of the first embodiment.

According to the first embodiment, the processing system 1 includes the plurality of processing servers 17 connected to the plurality of networks 120 with different address systems. With respect to each one or more application, for each of the plurality of modules constituting the application, the tunneling transmission table 1000 (the table that represents the module address and the processing server address for each of the plurality of modules) is included in the processing server 17 of the arrangement destination of the module among the plurality of processing servers, and the module is arranged in the processing server 17 of the arrangement destination. The processing server 17 in which the module is arranged specifies the processing server address of the processing server in which a module at a transmission destination of a packet is arranged from the tunneling transmission information configured in the processing server, and transmits the packet based on the specified processing server address.

The processing server address is an address that follows the address system of the network 120 to which the processing server 17 in which the module is arranged is connected, while the module address is an address that follows the address system of the virtual network. A system engineer (for example, an app developer) can determine the address of the module regardless of which network 120 the processing server 17 is connected to (that is, without considering the address structure of the network 120 to which the processing server 17 of the arrangement destination of the module is connected). Since it is preferable that the module address is not duplicated for the same virtual network, one module may belong to a plurality of virtual networks, or different modules belonging to different virtual networks may have the same address. This is useful in the environment where the network is wireless and different address systems can coexist. Based on the tunneling transmission table 1000 which represents the relationship between the module address and the processing server address, the packets transmitted and received between the modules can be transmitted and received between the processing servers 17. As a result, it is possible to set a system configuration including an application arrangement that appropriately follows the change in the field environment (for example, fluctuations in supply and demand or changes in processes). Specifically, for example, the system engineer does not need to consider the arrangement or connection method of the module, which facilitates the application development. The business operator who owns the processing system 1 does not need to coordinate with the system engineer, so that the application can be easily introduced.

With respect to each of the one or more applications, each of the plurality of modules constituting the application uses a virtual network corresponding to the address system of the module address assigned to the module among the one or more virtual networks for the communication between the modules In this way, it is not necessary to consider the address system of the network 120 to which the processing server 17 of the arrangement destination is connected in the arrangement of the module.

The plurality of processing servers 17 may include a plurality of edge processing servers 17E connected to the plurality of networks 120. This enables at least a part of the application to be implemented by the edge computing.

The plurality of processing servers 17 may further include a cloud processing server 17C, which is a cloud based processing server. The cloud processing server 17C has higher utilization efficiency than the edge processing server 17E, and therefore has a lower utilization cost. As a result, the application arrangement that achieves both performance and cost can be expected.

The plurality of networks 120 may include an MBH 120M and a LAN 120L. The MBH 120M is a network that connects the mobile core device 121 and the base station 16. The LAN 120L is the network connected to the mobile core device 121. These are examples of networks that follow local 5G or private LTE. In other words, the application arrangement that makes it possible to appropriately follow changes in the field environment is possible on the networks that follow the local 5G and the private LTE.

The processing system 1 includes the orchestration server 130 (an example of the management server) connected to the plurality of processing servers 17. For each of the one or more applications, for each of the plurality of modules constituting the application, the orchestration server 130 may set the tunneling transmission table 1000 for the processing server in the processing server 17 of the arrangement destination of the module among the plurality of processing servers 17, and arrange the module in the processing server 17 of the arrangement destination. This contributes to appropriately following the changes in the field environment. For example, the orchestration server 130 may specify the amount of free resources from the metric values of various metrics of each processing server 17, automatically determine the processing server 17 at the arrangement destination of the module based on the position and the amount of free resources of each processing server, and arrange the module in the determined processing server 17 at the arrangement destination. As a result, it can be expected that applications will be automatically arranged in response to the change in the field environment.

When the tunneling transmission table 1000 is set, each processing server 17 may be configured to set the virtual network I/F 402 for the virtual network to which the module belongs for each module arranged in the processing server 17, and may have the tunneling unit 400. The tunneling unit 400 may add the outer header including the processing server address to the packet including the inner header based on the tunneling transmission table 1000 set in the processing server 17. The tunneling transmission table 1000 set in the processing server 17 may include information representing the interface of the output destination for the module address of each module. In this way, the communication via the virtual network I/F 402 and the communication via the interface device 311 can be controlled.

For the packets received from the module in the processing server 17 including the tunneling unit 400 via the virtual network I/F 402 of the module, when the processing server address corresponding to the module address represented by the inner header in the packet can be specified from the tunneling transmission table 1000 set in the processing server, the tunneling unit 400 may add the outer header including the specified processing server address to the packet, and output the packet to which the outer header is added to the interface device 311 of the processing server. In this way, the communication of the packet received from the module in the processing server by the processing server can be realized.

The tunneling transmission table 1000 may include the VNID for the module address of each module. The outer header may include the VNID. For the packets received via the interface device 311 in the processing server 17 including the tunneling unit 400, when the outer packet is added to the received packet, based on the VNID represented by the outer header in the packet and the module address at the transmission destination represented by the inner header in the packet, the tunneling unit 400 may specify the virtual network I/F 402 at the output destination of the packet from the tunneling transmission table 1000, delete the outer header, and output the packet from which the outer header is deleted to the specified virtual network I/F 402. In this way, the packet received from the outside by the processing server can be transmitted to the module via the virtual network I/F 402.

When there is the device communication module, the orchestration server 130 may set the address conversion table 1100 that represents the correspondence between the module address of the module and the module external address for communicating with the device in the processing server 17 where the device communication module is arranged. For the packet received via virtual network I/F 402 from the module in the processing server 17 including the tunneling unit 400, when the processing server address corresponding to the module address in the packet cannot be specified from the tunneling transmission table 1000 set in the processing server 17, the tunneling unit 400 may specify the module external address corresponding to the module address in the received packet from the address conversion table 1100, and output the packet specifying the specified module external address to the interface device 311 of the processing server 17. In this way, the packet can be transmitted from the module to which a module address according to the address system of the virtual network is assigned to the external device.

When the outer header is not added to the packet received via the interface device 311, the tunneling part may specify the module address corresponding to the address specified in the packet from the address conversion table 1100, specify the virtual network I/F corresponding to the specified module address from the tunneling transmission table 1000, and output the packet to the specified virtual network I/F 402. In this way, the module can receive data from the external device.

### Second Embodiment

A second embodiment will be described. In this case, the differences from the first embodiment will be mainly described, and the common points with the first embodiment will be omitted or simplified.

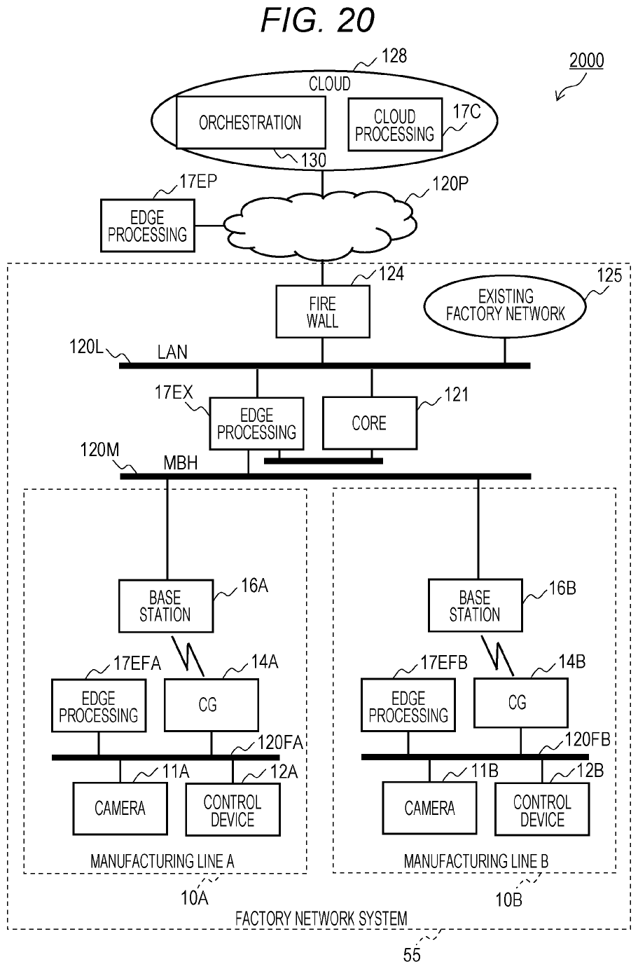

FIG. 20 is a diagram illustrating a configuration example of a processing system according to a second embodiment.

In a processing system 2000 according to the second embodiment, in place of the edge processing server 17EL connected to the LAN 120L and the edge processing server 17EM (17EMA and 17EMB) connected to the MBH 120M, an edge processing server 17EX (an example of a specific edge processing server) connected to the LAN 120L and the MBH 120M is provided. The edge processing server 17EX may be divided into a first logical edge processing server connected to the MBH 120M and a second logical edge processing server connected to the LAN 120L. Packets from the MBH 120M side may be received by the first logical edge processing server, and packets from the LAN 120L side may be received by the second logical edge processing server. Modules may be arranged for each logical edge processing server, and therefore each logical edge processing server may be provided with a tunneling unit or a virtual network I/F.

The edge processing server 17EX may receive the packet and determine whether the packet is a packet addressed to any processing server 17. When the result of the determination is true, the edge processing server 17EX may transmit the packet to the processing server of the address destination without passing through the mobile core device 121. When the result of the determination is false (for example, when the destination is the existing factory network 125), the edge processing server 17EX may transmit the packet to the mobile core device 121. The packet processing performed by the mobile core device 121 takes a relatively long time, but according to the second embodiment, the packet processing by the mobile core device 121 can be omitted for the packets transmitted and received between the processing servers 17. As a result, it can be expected to reduce the communication delay between the modules.

Although some embodiments have been described above, these are examples for explaining the present invention, and the scope of the present invention is not limited to these embodiments. The present invention can also be practiced in various other forms. For example, the network control unit 303 of the orchestration server 130 may periodically or aperiodically determine whether or not the amount of free resources of the processing server 17 at the arrangement destination of the module meets the requirements of the module. The network control unit 303 may move the module for which the result of the determination is negative to another processing server that satisfies the requirements of the module.

What is claimed is:

1. A processing system, comprising:
a plurality of processing servers that are connected to a plurality of networks with a different address system and each have a physical interface device for network communication,
wherein with respect to each of one or more applications, for each of a plurality of modules that constitute the applications and each input and output data,
a processing server at an arrangement destination of the module among the plurality of processing servers has tunneling transmission information which is information representing a module address and a processing server address for each of the plurality of modules,
the module is arranged in the processing server at the arrangement destination,
the module address is an address that follows an address system of a virtual network and is an address assigned to the module,
the processing server address is an address of the processing server in which the module is arranged and is an address that follows the address system of the network to which the processing server is connected, and
the processing server in which the module is arranged specifies the processing server address of the processing server in which a module at a transmission destination of a packet is deployed from the tunneling transmission information configured in the processing server, and transmits the packet based on the specified processing server address.

2. The processing system according to claim 1, wherein
the plurality of processing servers include a plurality of edge processing servers connected to the plurality of networks.

3. The processing system according to claim 2, wherein
the plurality of processing servers include a cloud processing server which is a cloud-based processing server.

4. The processing system according to claim 1, wherein
the plurality of networks include a first network and a second network through which the packet transmitted and received in wireless communication passes,
the first network is a network that connects a core network and one or more base stations, and
the second network is the network connected to the core network.

5. The processing system according to claim 4, wherein
the plurality of processing servers include a plurality of edge processing servers connected to the plurality of networks,
the plurality of edge processing servers include a specific edge processing server which is an edge processing server connected to the first network and the second network,
the specific edge processing server
receives the packet,
determines whether the packet is a packet addressed to any processing server,
transmits the packet without passing through the core network when a result of the determination is true, and
transmits the packet to the core network when the result of the determination is false.

6. The processing system according to claim 1, wherein
with respect to each of the one or more applications, each of the plurality of modules constituting the application uses a virtual network corresponding to the address system of the module address assigned to the module among the one or more virtual networks for the communication between the modules.

7. The processing system according to claim 6, further comprising:
a management server that is connected to the plurality of processing servers,
wherein with respect to each of the one or more applications, for each of the plurality of modules constituting the applications, the management server
sets the tunneling transmission information for the processing server in the processing server at the arrangement destination of the module among the plurality of processing servers, and
arranges the module in the processing server at the arrangement destination.

8. The processing system according to claim 7, wherein
the virtual network exists in each arrangement of one or more modules.

9. The processing system according to claim 7, wherein
each of the above plurality of processing servers
sets a virtual network interface, which is a virtual interface for the virtual network to which the module belongs, for each module arranged in processing server when the tunneling transmission information is configured, and
has a tunneling unit that adds an outer header including the processing server address to the packet including an inner header including the module address based on the tunneling transmission information configured in the processing server, and
the tunneling transmission information configured in the processing server includes information representing an interface at an output destination for the module address of each module.

10. The processing system according to claim 9, wherein
for the packet received from the module in the processing server including the tunneling unit via the virtual network interface of the module, when the processing server address corresponding to the module address represented by the inner header in the packet is specified from the tunneling transmission information configured in the processing server, the tunneling unit adds the outer header including the specified processing server address to the received packet, and outputs the packet to which the outer header is added to the interface device of the processing server.

11. The processing system according to claim 9, wherein
the tunneling transmission information configured in the processing server includes identification information of the virtual network for the module address of each module,
the outer header contains the virtual network identification information, and
for the packet received via the interface device in the processing server including the tunneling unit, when the outer header is added to the received packet, based on the identification information of the virtual network represented by the outer header in the packet and the module address at the transmission destination represented by the inner header in the packet, the tunneling unit specifies the virtual network interface at the output destination of the packet from the tunneling transmission information configured in the processing server, deletes the outer header, and outputs the packet from which the outer header is deleted to the specified virtual network interface.

12. The processing system according to claim 10, wherein
when the plurality of modules include a device communication module which is a module for communicating with a device, the management server configures address conversion information representing a correspondence between the module address of the module and a module external address for communicating with the module and the device in the processing server connected to the same network as the device, and
for the packet received from the module in the processing server including the tunneling unit via the virtual network interface of the module, when the processing server address corresponding to the module address in the packet is not able to be specified from the tunneling transmission information configured in the processing server, the tunneling unit specifies the module external address corresponding to the module address in the received packet from the address conversion information configured in the processing server, and outputs a packet for which the specified module external address is designated to the interface device of the processing server.

13. The processing system according to claim 12, wherein
when the outer header is not added to the packet received via the interface device in the processing server including the tunneling unit, the tunneling unit specifies the module address corresponding to the address specified in the packet from the address translation information, specifies the virtual network interface corresponding to the specified module address from the tunneling transmission information, and outputs the packet to the specified virtual network interface.

14. The processing system according to claim 12, wherein
for each of the one or more applications, the plurality of processing servers include a target processing server which is a processing server through which a packet entering and exiting a predetermined range in which the device exists necessarily passes,
the management server configures name resolving information representing a correspondence between a service name of the module and the module external address in the target processing server, and
when the target processing server receives a packet as a name resolving query in which the service name of the module is designated and specifies a module external address corresponding to the service name from the name resolving information, the target processing server returns the specified module external address to the device.

15. The processing system according to claim 7, wherein
when the management server detects that a state of environment to be monitored corresponds to an un-deployed application, the management server determines the application as a deployment target, and for each of the plurality of modules constituting the application,
the management server determines the processing server of the arrangement destination of the module, and
arranges the module in the processing server at the determined arrangement destination.

16. The processing system according to claim 15, wherein
the management server periodically collects metric values from each processing server, and
a state in which the state of the environment to be monitored corresponds to the un-deployed application means that the metric values of each processing server correspond to a metric value range corresponding to the un-deployed application.

17. The processing system according to claim 7, wherein
the management server determines, as an application to be deleted, an application to be deployed instead, which does not correspond to the state of the environment to be monitored, among the existing applications, and in order to delete the application, for each of the plurality of modules constituting the application,
the management server deletes the application from the processing server of the arrangement destination of the module, and
deletes the tunneling transmission information on the application arrangement from the processing server at the arrangement destination.

18. A processing server connected to one of a plurality of networks with different address systems, the processing server comprising:
a physical interface device that is connected to the network;
a storage device; and
a processor that is connected to the interface device and the storage device,
wherein with respect to each of one or more applications, a plurality of modules that constitute the applications and each input and output data are connected to the plurality of networks and are arranged in a plurality of processing servers including the processing server,
with respect to each of the one or more applications, the storage device stores tunneling transmission information which is information representing a module address and a processing server address for each of the plurality of modules constituting the application,
the module address is an address that follows an address system of a virtual network and is an address assigned to the module,
the processing server address is an address of the processing server in which the module is arranged and is an address that follows the address system of the network to which the processing server is connected, and
the processor specifies a processing server address of the processing server in which a module at a transmission destination of the packet including the data transmitted or received by the module arranged in the processing server is arranged from the tunneling transmission information, and transmits a packet based on the specified processing server address.

19. A processing method performed by a processing server connected to one of a plurality of networks with different address systems, the processing method comprising:
with respect to each of one or more applications, storing tunneling transmission information which is information representing a module address and a processing server address for each of a plurality of modules constituting the applications and each input and output data,
wherein the module address is an address that follows an address system of a virtual network and is an address assigned to the module, and the processing server address is an address of the processing server in which the module is arranged and an address that follows an address system of the network to which the processing server is connected, and
the module arranged in the processing server specifies a processing server address of the processing server in which a module at a transmission destination of the packet including the data transmitted or received by the module arranged in the processing server is deployed from the tunneling transmission information, and transmits a packet based on the specified processing server address.
